(19) United States
(12) Patent Application Publication
(10) Pub. No.: US 2005/0025128 A1
(43) Pub. Date: Feb. 3, 2005

(54) Integration of an IP private branch exchange with a telecommunication switch provides users with additional features

(76) Inventor: Tienyu Chiu, Naperville, IL (US)

Correspondence Address: PATTI & BRILL, ONE NORTH LASALLE STREET, 44TH FLOOR, CHICAGO, IL, 60602, US

(21) Appl. No.: 10/633,060

(22) Filed: Aug. 1, 2003

(51) Int. Cl. H04L 12/66

(52) U.S. Cl. 370/352

(57) ABSTRACT

Call features such as available to subscribers of a Centrex telecommunications system are made available to subscribers using internet protocol telephone sets. An internet protocol peripheral unit provides an interface between conventional IP packets utilized by IP telephone sets and the required message and signaling required by a packet line truck unit associated with a switch module of the switch. This permits IP telephone set users to be able to access the applications processor and its associated directory database. Such access is needed to implement certain call features.

### BACKGROUND

This invention is generally directed to telecommunication services and is more specifically directed to private branch exchanges (PBXs) and services made available to users by a PBX.

Commonly known circuit private branch exchanges are normally located remote from a supporting telecommunications switch and are normally installed near the customers to be served by the PBX. For example, employees of a business occupying several floors of a large office building would be served by a PBX located in the office building. Such a PBX would be typically owned by the business, i.e. the customers served, and could be connected to a supporting class 5 telecommunication switch by an ISDN primary rate interface (PRI) communication line. A circuit PBX provides a substantial number of features to its customers such as the ability of a customer to utilize abbreviated digit dialing when calling another customer also supported by the PBX.

Another type of PBX is an Internet protocol (IP) PBX. The IP PBX is similar to the circuit PBX in that is normally purchased by the business that it supports and is located at the location of the business. The IP PBX typically interfaces to a class 5 telecommunication switch by a PRI or Session Initiation Protocol (SIP) communication line. It is similar to the circuit PBX in that it provides a substantial number of features to its customers. The IP PBX provides an interface for and supports the connection of IP telephone sets that carry customer communications by IP packets.

Although the IP PBX provides a variety of call related features to the supported customers, some features that would be available from a telecommunication switch's Centrex facility are not available to customers of an IP PBX. For example, a number of electronic directory service (EDS) features, such as calling name display, directory query display and auto call, which would be available to a subscriber of Centrex services, are not available to customers of an IP PBX. One reason why such services are not available to customers of an IP PBX is that an interface is not available to the applications processor (AP) associated with the supporting class 5 switch. The applications processor is coupled to and facilitates communications with a directory database that contains attributes associated with each subscriber such as the person's name, telephone number, location, organization, etc. Since the IP PBX is an external peripheral from the perspective of the supporting class 5 switch, communications and messages between the switch's applications processor and the IP PBX are not supported. Therefore, a need exists to provide a full range of call features for IP telephone set subscribers.

### SUMMARY OF THE INVENTION

It is an object of the present invention to provide a solution for this need.

In accordance with an embodiment of the present invention, a method is implemented by a supporting switch to provide IP telephone set subscribers with call features such as found in Centrex systems. An IP peripheral unit, IPPU, of the switch receives a first IP packet from an IP subscriber containing a request for a first call feature. The IPPU converts the first IP packet into a second message transmitted to a packet line trunk unit (PLTU) of a switch module over a PCTFI interface, where the second message contains the request for the first call feature. First information contained in a directory database is accessed by an applications processor based on the request for the first call feature contained in the second message. The applications processor retrieves at least a portion of said first information. The retrieved portion of the first information is utilized to implement the requested call feature by the IP telephone set subscriber.

### BRIEF DESCRIPTION OF THE DRAWINGS

FIG. 1 is a block diagram of a telecommunication network including an IP PBX in accordance with the prior art.

FIG. 2 is a block diagram of a telecommunication network that supports an embodiment of the present invention.

FIG. 3 is a block diagram of a peripheral control and timing interface card as shown in FIG. 2.

FIG. 4 is a flow diagram illustrating the operation of the peripheral control and timing interface card in processing incoming packets.

FIG. 5 is a flow diagram illustrating the operation of the peripheral control and timing interface card in processing outgoing packets.

FIG. 6 is a signal diagram illustrating the display of a calling name feature.

FIG. 7 is a signal diagram illustrating the display of a directory query feature.

### DETAILED DESCRIPTION

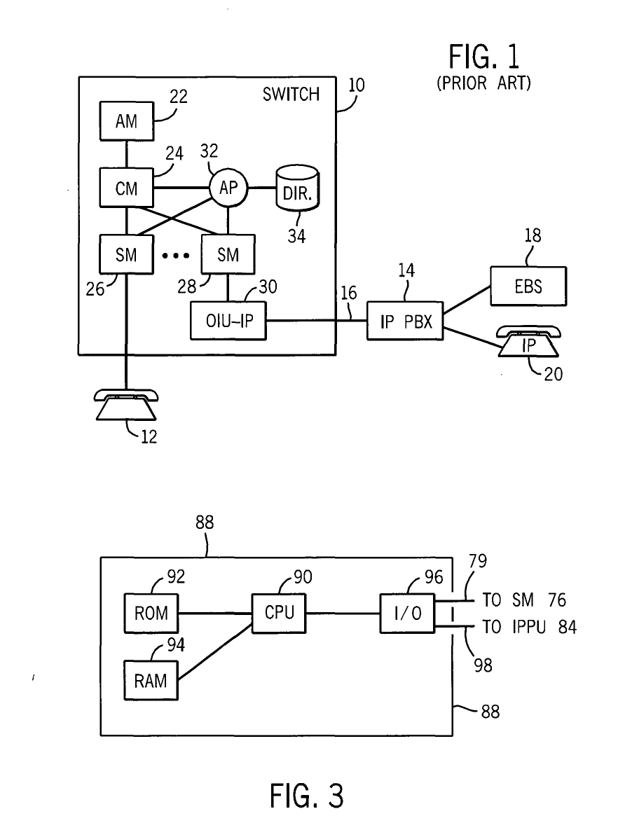

FIG. 1 shows a prior art telecommunications network in which telecommunications switch 10 supports a conventional telephone set 12 that may be an analog telephone set or an ISDN telephone set. An IP PBX 14 is coupled to the switch 10 by optical communication line 16. The IP PBX 14 is also coupled to an enhanced business services (EBS) peripheral 18 and an exemplary IP telephone set 20. The EBS peripheral 18 supports the IP PBX and provides enhanced business services and call features for customers such as IP telephone set 20.

Telecommunication switch 10, which may comprise a class 5 telecommunication switch such as the 5ESS® switch available from Lucent Technologies Inc. that includes an administrative module (AM) 22, a communications module (CM) 24, and a plurality of switch modules (SM) represented by switch modules 26 and 28. The administrative module 22 is responsible for the overall call routing and control functions, as well as operations, administration and maintenance functions. The communications module 24 is responsible for interconnecting information contained in time slots representing telephone calls between the switch modules. The switch modules 26 and 28 provide a termination for subscriber and trunk lines and translate the information contained on these lines into information carried by respective time slots. An optical interface unit 30 that supports IP protocol communications (OIU-IP) provides an interface between switch module 28 and the optical trunk line 16 coupled to IP PBX 14. An applications processor 32 is coupled to the switch modules and to a directory database 34 that contains subscriber information and attributes relating to each subscriber such as a person's name associated with a directory telephone number, location, organization, position within the organization, etc. However, because the IP PBX 14 is an external peripheral of switch 10, communications and messages between the IP PBX 14 and the applications processor 32 are not supported. Hence, an IP telephone set subscriber 20 of IP PBX 14 can be provided with services and call features such as through EBS peripheral 18, but the IP telephone set subscriber cannot be offered call features that require support of the applications processor 32.

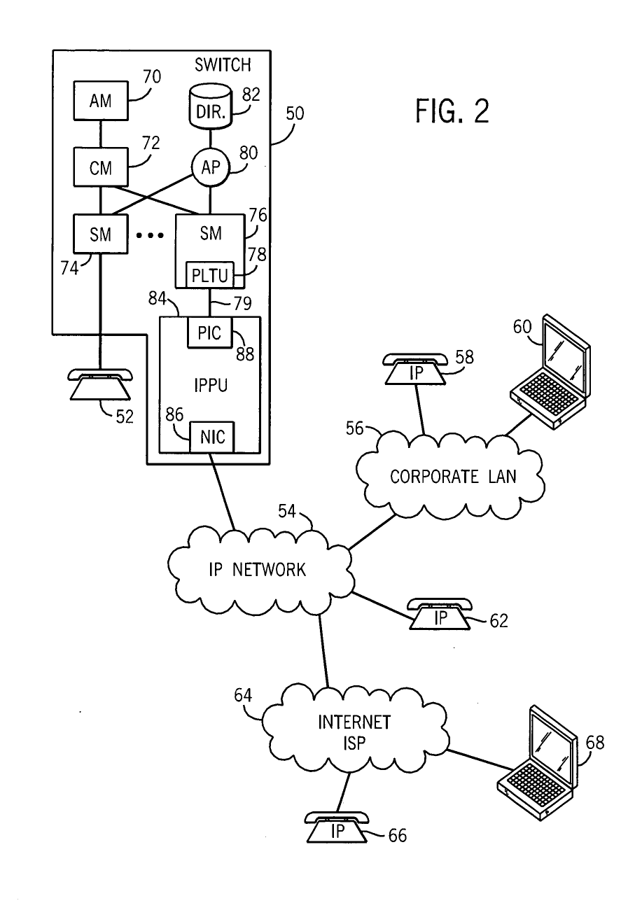

In FIG. 2 the telecommunication network includes an exemplary telecommunications switch 50 in accordance with the present invention that supports a conventional analog or ISDN telephone set 52. IP network 54 is also coupled to and supported by the switch 50. The IP network 54 provides a gateway to other networks and end-user devices utilizing IP communications. The IP network 54 is coupled to a corporate local area network (LAN) 56 that supports exemplary IP telephone set 58 and a computing device (IP soft phone) 60 that utilizes IP communications to carry voice and/or data. An Internet protocol telephone set 62 is directly supported by IP network 54. An Internet service provider (ISP) network 64 is coupled to IP network 54 and supports IP telephone set 66 and computing device 68.

Telecommunication switch 50 is preferably based on a class 5 switch such as a 5ESS® switch available from Lucent Technologies Inc. It includes an administrative module 70, a communications module 72, and exemplary switch modules 74 and 76. Switch module 76 includes a commercially available packet line trunk unit (PLTU) 78 that supports communications via peripheral control & timing facility interface 79. An applications processor 80 is coupled to the switch modules and to a directory database 82. An Internet protocol peripheral unit (IPPU) 84 includes network interface card (NIC) 86 and a peripheral control and timing (PCT) interface card (PIC) 88. The IPPU 84 can comprise an iMerge Centrex Feature Gateway available from Lucent Technologies Inc. modified by the addition of PIC 88 that will be described below.

FIG. 3 is a block diagram of the peripheral control and timing interface card 88 that provides an interface between the protocol and signaling required by the packet line trunk unit 78 of switch module 76 and the IP signaling and protocol utilized by conventional IP packets received from and transmitted to IP subscribers of the IPPU 84. A central processing unit (CPU) 90 is supported by read-only memory (ROM) 92 and random access memory (RAM) 94. An input/output module (I/O) 96 facilitates communications between the CPU 90 and the PLTU 78 of SM 76 by communication line 79 and the IPPU 84 by communication channel 98. The IPPU 84 contains its own separate processing module. The CPU 90 operates under stored program instructions initially residing in ROM 92 and residing jointly in ROM 92 and RAM 94 during operation.

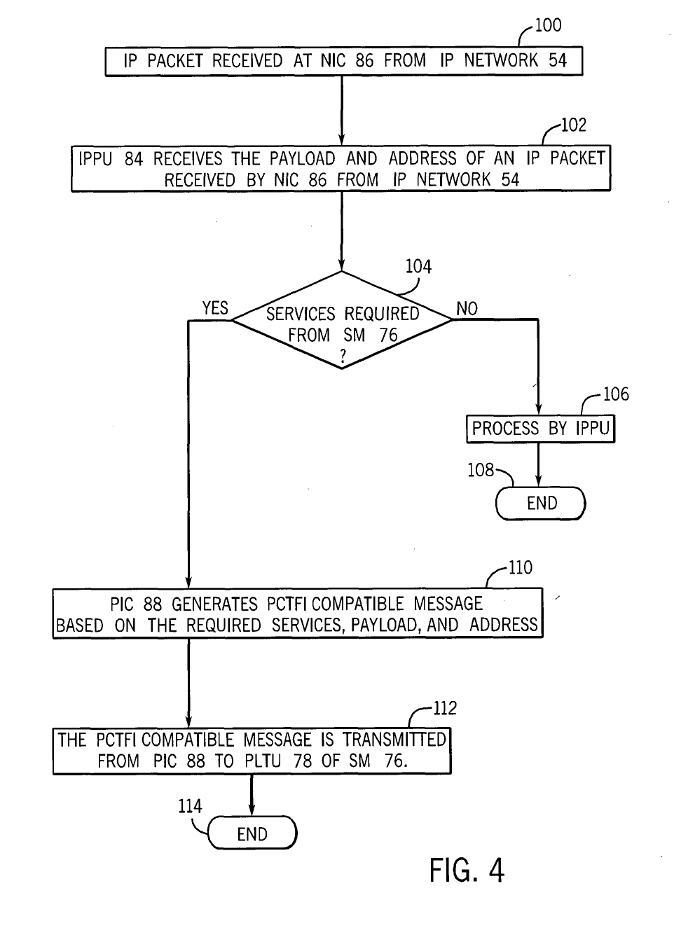

In FIG. 4, the role of the peripheral control and timing interface card 88 is explained with regard to the processing of an incoming IP packet from IP network 54. An IP packet is received at NIC 86 from the IP network 54 at step 100. In step 102 the IPPU 84 receives the payload and address of an IP packet received by NIC 86 from IP network 54. A determination is made in step 104 of whether services are required from SM 76. A NO determination by step 104 indicates that services are not required from the switch module, i.e. there are no communications from an end subscriber to be transmitted to the SM and there are no command and control messages to be sent to the SM. Thus, the packet is processed by the IPPU itself in step 106. The process concludes at END step 108.

A YES determination by step 104 indicates that information (user communications or command signaling) is required to be transmitted to the SM. In step 110 PIC 88 generates a PCT facilities interface (PCTFI) compatible message based on the required services, payload, and address associated with the incoming packet. In step 112 the PCTFI compatible message is transmitted from PIC 88 to PLTU 78 of the SM 76. The common interface and protocol between the PLTU and the PIC is referred to as PCTFI. Processing concludes at END step 114.

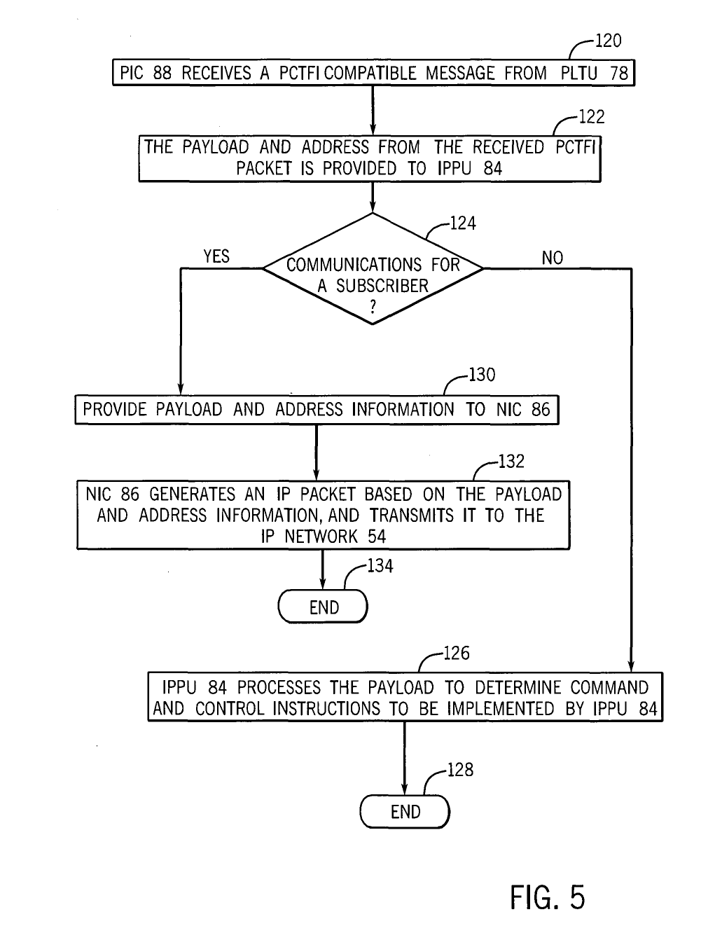

FIG. 5 is a flow diagram illustrating exemplary steps for processing outgoing packets. In step 120 PIC 88 receives a PCTFI compatible message from PLTU 78. In step 122 the payload and address from the received PCTFI message is recovered by PIC 88 and is provided to IPPU 84. In step 124 a determination is made of whether the received communication is for a subscriber. An outbound message from the PLTU to the PIC can contain either communications intended for a subscriber or command and control information that provide instructions or request information from the IPPU. A NO determination by step 124 results in the IPPU 84 processing the payload to determine the command and control instructions to be implemented by the IPPU in step 126. The processing concludes at END step 128.

A YES determination by step 124 results in the payload and address information being transferred from the IPPU 84 to the NIC 86 in step 130. In step 132 the NIC 86 generates an IP packet based on the payload and address information, and transmits it to the IP network 54. The process concludes at END step 134. Thus, outgoing messages may contain command and control information for IPPU 84 or communications to be forwarded to a subscriber.

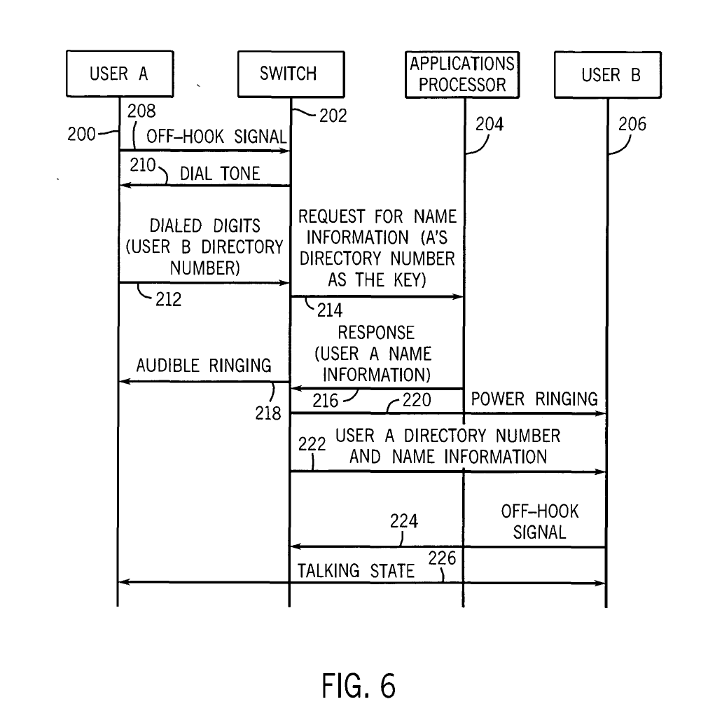

FIG. 6 shows an exemplary signal diagram of a calling name display feature in which the name of the calling party is displayed on an IP telephone set of the called party. In this example, user A and user B represented by vertical lines 200 and 206, respectively, belong to the same PBX (Centrex business) group, e.g. both may be employees of the same company. With reference to FIG. 2, user A is associated with IP telephone set 58 and user B is associated with IP telephone set 62. The switch 202 and applications processor 204 are represented in FIG. 2 by switch 50 and applications processor 80, respectively.

In order to better appreciate the significance of the feature implemented by the signaling diagram, it will be helpful to understand the advantages provided over current IP PBX systems. In a current IP PBX system, assuming users A and B belong to the same PBX group and that user A calls B by dialing B's extension telephone number, user B would not have displayed on his telephone set user A's name, calling number (user A's number) or other information about user A. Changing the scenario, if users A and B belonged to a Centrex calling group, then the telephone set of the called party B would display the name and directory number of the calling party A. As will be explained with regard to FIG. 6, an embodiment of the present invention provides the same ability display the name and directory number of the calling party to the called party where the calling and called parties belong to the same call group of an IP PBX system.

The calling party 200 (IP telephone set 58) and the called party (IP telephone set 62) both belong to the same business group. User A generates an off hook signal 208 that is transmitted to switch 202 (switch 50) by an IP packet transmitted through corporate LAN 56, IP network 54 to the NIC 86 of IPPU 84. This information is translated into an appropriate PCTFI message transmitted from PIC 88 to PLTU 78 of SM 76. Upon determining that call capacity exists a handle the newly requested incoming call, switch 202 generates a dial tone signal 210 that flows through PLTU 78, PIC 88, NIC 86, IP network 54, and corporate LAN 56 to IP telephone set 58. This results in dial tone being provided user A. User A enters the directory number of user B as indicated by signal 212. Since both users are members of the same call group, the dialed directory number may consist of only the extension number associated with user B. The dialed digits are transmitted to switch 202 as a message(s). Upon receiving the extension number of user B, switch 202 recognizes that the requested call is to another user of the same call group and user B is equipped with the calling name display feature, the switch 202 transmits a signal 214 to applications processor 204 requesting name information associated with the calling party based on the calling party's directory number that was transmitted to the switch as part of the call origination. The applications processor 204 locates a record stored in the directory database 82 corresponding to the calling party's directory number, and retrieves the stored name of user A. Applications processor 204 transmits the retrieved name information of user A by signal 216 to switch 202.

Switch 202 generates a signal 218 transmitted to user A causing the IP telephone set 58 to generate an audible ringing tone to the calling party, user A. The switch 202 also generates a signal 220 transmitted to user B causing the IP telephone set 62 to initiate ringing. The switch 202 further sends a signal 222 to the user B's IP telephone set that carries the directory number and name of the calling party, user A. Upon answering the incoming call by user B, an off hook signal 224 is transmitted from the IP telephone set 62 to the switch 202. Upon receipt of the off hook signal, switch 202 establishes a two-way bearer communication path, talking path 226, between users A and B to facilitate user communications.

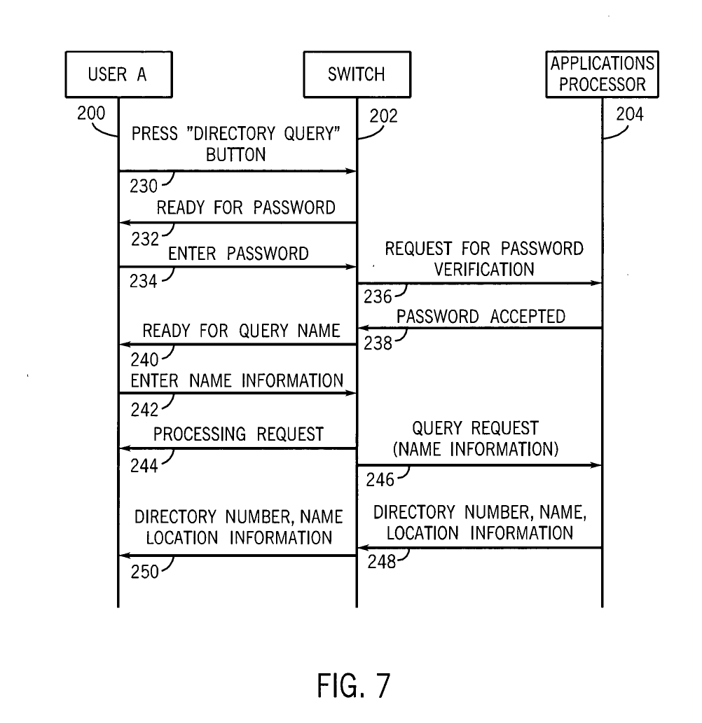

FIG. 7 illustrates an exemplary directory query feature in which an IP PBX user is provided with the capability to conduct a directory query to locate the name and/or directory number of another user of the same business group. User A presses a “directory query” button on IP telephone set 58 causing signal 230 to be transmitted to switch 202 in a packet traversing corporate LAN 56, IP network 54, NIC 86, translated into a PCTFI compatible message by PIC 88 that is transmitted to PLTU 78 of SM 76. On receipt of the request, switch 202 transmits a signal 232 requesting the entry of a password by user A that is carried as a PCTFI compatible message from PLTU 78 to PIC 88 where it is transmitted by NIC 86 as a conventional IP packet that traverses IP network 54 and corporate LAN 56 to reach IP telephone set 58. Typically, this request will be displayed on the screen of an IP telephone set 58. In order to authenticate the ability of user A to access the directory information of the calling group, user A enters a password such as a personal identification number that is transmitted to switch 202 as indicated by signal 234. Switch 202 requests verification of the received password by transmitting a request signal 236 to applications processor 204 that includes the received password from user A. Applications processor 204 identifies a record associated with user A and confirms that the entered password is valid. Applications processor 204 transmits signal 238 to switch 202 indicating the validity of the password.

Switch 202 transmits a signal 240 to user A indicating that the user can proceed with the desired name query; this indication will typically be shown on display of the user's IP telephone set. User A then proceeds to enter a series of digits representing the alphabetical spelling of the desired name as indicated at signal 242 that is transmitted to switch 202. On receipt of the query, switch 202 transmits a signal 244 to user A indicating that the requested query is being processed; typically this information will be shown on the display of user A. The switch 202 transmits a query request containing the received name from user A as signal 246 to applications processor 204. The applications processor 204 provides a search of the directory database 82 to identify a record corresponding with the input name. Upon locating a corresponding record, applications processor 204 transmits a signal 248 to switch 202 containing the relevant information associated with the record that may include the directory number, name, location, position in the organization, etc. The switch 202 relays the received relevant information as signal 250 to user A and the information is displayed on user A's IP telephone set 58. Thus, user A as an IP PBX user is provided with a capability that supports directory queries just as would have been made available to a Centrex subscriber.

Another advantage of the present invention is that operations, administration, maintenance and provisioning (OAM&P) is integrated for the switch and the IP interface, the IPPU of the embodiment. As shown in FIG. 1 the OAM&P functions for the switch 10 and IP PBX 14 would be managed separately.

Various changes and additions can be made to the illustrative embodiments by those skilled in the art. The present invention is not limited to the specific embodiments shown. The scope of the present invention is defined by the claims that follow.

1. A method implemented by a supporting switch for providing Internet Protocol, IP, telephone set subscribers with call features comprising the steps of:
receiving at an IP peripheral unit, IPPU, a first IP packet containing a request for a first call feature;
transmitting a second message from the IPPU to a packet line trunk unit of a switch module where the second message contains the request for the first call feature;
accessing first information contained in a directory database by an applications processor based on the request for the first call feature contained in the second message;
the applications processor retrieving at least a portion of said first information;
transmitting said at least portion of the first information to an IP telephone set subscriber in response to the request for the first call feature.

2. The method according to claim 1 wherein said at least portion of the first information is transmitted to the IP telephone set subscriber that made the request for the first call feature.

3. The method according to claim 1 wherein said request for the first call feature is from a calling party, and said at least portion of the first information is transmitted to a called IP telephone set subscriber.

4. The method according to claim 1 wherein the transmitting of the second message comprises transmitting a second message that is compatible with peripheral control and timing facilities interface protocol.

5. The method according to claim 1 wherein the first call feature is one of a group including calling name display and directory query display.

6. A method implemented by a supporting switch for providing Internet Protocol, IP, telephone set subscribers with call features comprising the steps of:
receiving at an IP peripheral unit, IPPU, a first IP packet containing a request for a first call feature;
transmitting a message based on the request for the first call feature to an applications processor;
locating first information contained in a directory database by the applications processor based on the request for the first call feature;
the applications processor retrieving at least a portion of said first information;
transmitting said at least portion of the first information to an IP telephone set subscriber in response to the request for the first call feature.

7. The method according to claim 6 wherein said at least portion of the first information is transmitted to the IP telephone set subscriber that made the request for the first call feature.

8. The method according to claim 6 wherein said request for the first call feature is from a calling party, and said at least portion of the first information is transmitted to a called IP telephone set subscriber.

9. The method according to claim 6 wherein the transmitting of the message comprises transmitting a message that is compatible with peripheral control and timing facilities interface protocol.

10. The method according to claim 6 wherein the first call feature is one of a group including calling name display and directory query display.
